(19) United States
(12) Patent Application Publication
(10) Pub. No.: US 2016/0059516 A1
(43) Pub. Date: Mar. 3, 2016

(54) Compression Fabric Composites and Methods of Making and Using the Same

(71) Applicant: Angel 7 Industries, LLC, San Antonio, TX (US)

(72) Inventor: Kerry S. Harris, San Antonio, TX (US)

(21) Appl. No.: 14/473,623

(22) Filed: Aug. 29, 2014

(51) Int. Cl. B32B 5/26; B32B 27/40; B32B 7/04; B32B 5/02; B32B 7/08; B32B 7/12

(52) U.S. Cl. CPC B32B 5/26; B32B 7/08; B32B 7/12; B32B 7/04; B32B 5/028; B32B 27/40; B32B 2305/18; B32B 2307/51; B32B 2437/00; B32B 2307/724; B32B 2307/5825

(57) ABSTRACT

The present invention relates to a stretchable fabric composite. Specifically, the fabric composite comprises a first layer comprising a stretchable fabric and a second layer comprising an elastic polymer; wherein the first layer and second layer are bonded together forming the fabric composite. The fabric composite is useful for constructing a garment or a compression article. A method of making the fabric composite is also provided.

### TECHNICAL FIELD

The present invention relates to a stretchable fabric composite. Specifically, the fabric composite comprises a first layer comprising a stretchable fabric and a second layer comprising an elastic polymer; wherein the first layer and second layer are bonded together forming the fabric composite. The fabric composite is useful for constructing a garment or a compression article. A method of making the fabric composite is also provided.

### BACKGROUND

Athletes, whether professional or weekend warriors, are always looking for the next best in high performance materials and clothing, to enhance the workout, wick moisture, reduce odor and keep cool or warm during the workout. Because workout clothing is washed often, there is also a need for low maintenance washing requirements, little to no shrinkage from repeated washings, and preferable quick drying.

Compression clothing has become almost a necessity in all forms of sportswear. Use of compression clothing is being researched for its possible effects on improving overall performance of the athlete. For example, some companies claim their compression clothing, if worn during athletic activities, will increase blood flow and focus muscle energy for improved performance, while diminishing soreness, tightness and possible injury. Some studies suggest wearing compression gear after a workout diminishes fatigue, swelling and inflammation. Regardless of these claims, the comfort, strength and breathability features of compression garments are requirements for athletic use.

In addition, compression style items are also useful in the medical industry, for example to aid in the prevention of deep vein thrombosis and as a means to help manage the post-thrombotic syndrome. Graduated compression hosiery is known for managing varicose veins and used for everyday wear to prevent tired, swollen and generally uncomfortable legs associated with travel and pregnancy. Compression wraps have also been designed to address specialized needs of both athletes and medical patients associated with pivoting joints, such as the elbow or knee. The compression force of these types of devices helps to minimize fatigue, keep the joints from swelling, and keep joint mechanics in the proper position.

Compression sports apparel and compression medical items are often constructed from Lycra®, which is the commercial name for elastane or spandex. Spandex is a light textured, synthetic polymer, which provides garments with stretchy characteristics. Benefits of spandex include its strength and elasticity, the ability to return to the original shape after stretching, and faster drying than ordinary fabrics. All of these characteristics are desirable in athletic wear and in compression devices used in medical applications.

However, Lycra® spandex can have its disadvantages. For example, certain spandex garments can lack breathability, have a slick smoothness on certain surfaces, require more careful washing and handling, and due to its close-fitting nature, may accentuate the body flaws of the wearer. The inability to breathe moisture during sweat-inducing activities may lead to an unpleasant odor, particularly when the clothing is worn during sweat-inducing activities. Trapping sweat near the skin may also lead to an increase risk of yeast infections and blistering along clothing seams. In an attempt to avoid the undesirable side effects associated with the inability to release moisture, clothing manufacturers may incorporate other materials into their spandex garments to impart breathability. Additionally, the inherent slickness of spandex may cause the wearer to slide off a sitting surface, including exercise apparatus and equipment. Spandex is also sensitive to heat, so washing in hot water and drying garments in a hot dryer may damage them. Finally, spandex garments, because they grip the body of the wearer tightly, may unintentionally show the wear's flaws, dimples or rolls.

Therefore, a need remains for garments and compression medical items constructed from a strong, breathable, tear-resistant fabric, easily washable and that maintains elasticity longer to meet the needs of athletes and the medical community alike. Furthermore, there is a need for the material to be made into just about any garment, including compression shirts, shorts, undergarments, and support items, including sleeves for elbows, knees, ankles and wrists.

Moreover, certain clothing and/or accessories, such as gloves and the like may be desired for their gripping ability. For example, football receivers, baseball batters, and soccer goalies may typically use gloves to enhance their gripping ability. Typically, these articles include a layer of solid gripping material disposed over the article, such as a glove or other like article. However, gloves or other accessories designed to aid a user's gripping ability may suffer the same problems associated with Lycra® and other spandex clothing noted above—namely, lack of breathability and moisture wicking properties that can remove moisture from a user's skin. Oftentimes, the layer of gripping material increases stiffness and decreases bendability of the article, reducing the article's effectiveness for its design purpose. In addition, the layer of gripping material can degrade over time, especially because the gripping material is utilized often to frictionally contact an item, such as a football, a baseball bat, or a soccer ball. A need, therefore, exists for an article such as a glove or other like accessory having increased gripping ability without sacrificing breathability and bendability of the article. Still further, a need exists for an article providing a user with enhanced gripping properties while remaining resilient in toughness and strength.

### SUMMARY OF THE INVENTION

The present invention relates to a stretchable fabric composite. Specifically, the fabric composite comprises a first layer comprising a stretchable fabric and a second layer comprising an elastic polymer; wherein the first layer and second layer are bonded together forming the fabric composite. The fabric composite is useful for constructing a garment or a compression article. A method of making the fabric composite is also provided.

To this end, in an embodiment of the present invention, a multilayer fabric composite is provided. The multilayer fabric composite comprises: a first layer comprising a stretchable fabric; and, a second layer comprising an elastic polymer in a lattice pattern, wherein the first layer and second layer are bonded together forming the composite.

In an embodiment, the first layer comprises spandex.

In an embodiment, the second layer comprises an elastic polyurethane.

In an embodiment, the lattice pattern is selected from the group consisting of an open lattice pattern and a reverse lattice pattern.

In an embodiment, the composite further comprises a middle adhesive layer bonding the first layer and the second layer together.

In an embodiment, the first layer and the second layer are bonded together through a process selected from the group consisting of sonic welding, thermal welding, adhesive and mechanical bonding.

In an embodiment, the second layer has a tacky side and a smooth side, wherein the tacky side is bonded together with the first layer and the smooth side is exposed.

In an embodiment, the second layer has a tacky side and a smooth side, wherein the smooth side is bonded together with the first layer and the tacky side is exposed.

In an embodiment, the composite is stretchable in at least one direction.

In an embodiment, the composite is stretchable in a plurality of dimensions.

In an alternate embodiment of the present invention, a compression fabric for use in garments is provided. The compression fabric comprises: a first layer comprising a stretchable fabric; and, a second layer comprising an elastic polymer, wherein the second layer forms an open lattice pattern, wherein the first layer and the second layer are bonded together via thermal, adhesive, ultra-sonic or mechanical bonding forming a fabric for use in constructing a compression garment.

In an embodiment, the first layer is spandex.

In an embodiment, the second layer is an elastic polyurethane.

In an embodiment, the open lattice pattern is a discontinuous open pattern.

In an embodiment, the second layer has a webbing configuration.

In an embodiment, the compression garment is an elbow support.

In an embodiment, the compression garment is a knee support.

In an embodiment, the compression garment is a compression shirt.

In an embodiment, the compression garment is compression shorts.

In an alternate embodiment of the present invention, a method for constructing a compression item is provided. The method comprises the steps of: providing a first layer comprising a stretchable fabric; providing a second layer comprising an elastic polymer having a lattice configuration; bonding the first layer with the second layer to form a composite fabric; and, constructing a compression item having a desired shape.

It is, therefore, an advantage and objective of the present invention to provide a strong, abrasion and tear resistant fabric composite.

Specifically, it is an advantage and objective of the present invention to provide a breathable, easily washable fabric composite.

Moreover, it is an advantage and objective of the present invention to provide a fabric composite that maintains its compression and elasticity characteristics longer than known fabrics.

Further, it is an advantage and objective of the present invention to provide an article such as a glove or other like accessory having increased gripping ability without sacrificing breathability and bendability of the article.

Still further, it is an advantage and objective of the present invention to provide an article providing a user with enhanced gripping properties while remaining resilient in toughness and strength.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 shows an illustration of a fabric composite according to the present disclosure;

FIG. 2 illustrates a garment constructed from the fabric composite of the present disclosure;

FIG. 3 illustrates a garment constructed from the fabric composite of the present disclosure;

FIG. 4 illustrates a garment constructed from the fabric composite of the present disclosure; and,

FIG. 5 illustrates a garment constructed from the fabric composite of the present disclosure.

### DETAILED DESCRIPTION

The present invention relates to a stretchable fabric composite. Specifically, the fabric composite comprises a first layer comprising a stretchable fabric and a second layer comprising an elastic polymer; wherein the first layer and second layer are bonded together forming the fabric composite. The fabric composite is useful for constructing a garment or a compression article. A method of making the fabric composite is also provided.

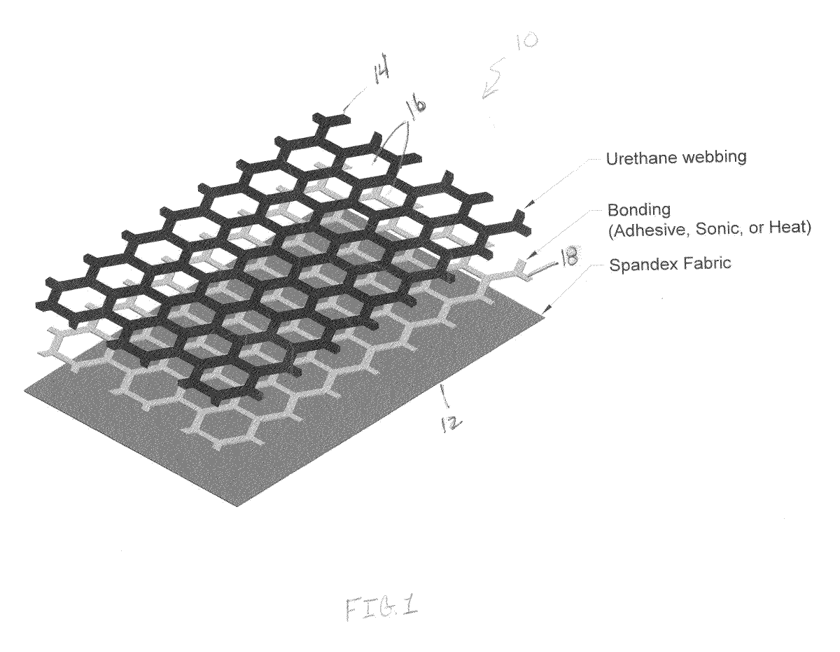

Now referring to the figures, wherein like numerals refer to like parts, FIG. 1 illustrates an exploded view of the multilayer, non-woven fabric composite 10 of the present disclosure. The fabric composite 10 comprises a first layer 12 of a stretchable fabric and a second layer 14 of an elastic polymer. The first layer 12 can be constructed from continuous sheet of any suitable stretchable fabric, including spandex, but may also include other stretchable fabrics, including other thermoplastic woven or molded fabric, such as nylon and neoprene. The first layer 12 may be any thickness useful for use as an article of clothing, an accessory, or other like article, and the present invention should not be limited as described herein.

Preferably, the stretchable fabric is made from a material that is stretchable in at least one direction. More preferably, the stretchable fabric is made from a material that is stretchable in at least two directions. Most preferably, the stretchable fabric is stretchable in all directions. In addition, if the stretchable fabric is stretchable in at least two directions, then the stretchability in one direction may be the same or different than the stretchability in the other direction, having symmetric stretch or asymmetric stretch, respectively.

The second layer 14 can be constructed from an elastic polymer, including an elastic urethane, silicone, an elastomer and a rubber material. Preferably, the elastic polymer is an elastic polyurethane known commercially as urethane. The second layer 14 may have any thickness apparent for use in articles, such as in compression articles, such as clothing, sleeves, gloves, or the like.

Unlike the first layer 12, which is shown as a continuous sheet of material, the second layer 14 is presented as an open lattice pattern 16, webbing configuration, or open woven pattern. It should be understood that one embodiment of the pattern 16 is represented in FIG. 1, the pattern of the second layer 14 can have any shape, including circles, triangles, squares, rectangles, or any suitable geometric shape. Additionally, the pattern 16 may be organized, such as the lattice pattern shown, or more random, across the second layer 14. The pattern 16 may be any suitable size, ranging from a millimeter to several inches.

In addition, certain lattice patterns, such as a triangular pattern, a square pattern, a rectangular pattern, a hexagonal pattern, or any other pattern forming a lattice pattern may provide more one-directional strength to the resulting fabric composite, than perhaps a circular pattern. The open, discontinuous pattern 16 of the second layer 14 provides the fabric composition 10 with a variety of advantages over other known fabrics, including increased breathability, strength and stretchability.

Likewise, the second layer 14 may be presented as a closed or reverse lattice pattern, where the pattern comprises thin open lines forming a lattice pattern whereby the elastic polymer remains in the form of the geometric patterns and the thin open lines form the spaces between the geometric shapes of the elastic polymer.

Of course, the geometric shapes formed by the elastic polymer in the reverse lattice pattern may be interconnected together to form a continuous pattern thereof for ease of use.

The second layer 14 of elastic polymer may preferably be formed from a continuous sheet of elastic polymer that may be cut or scored to form the lattice pattern. Preferably, the continuous sheet of elastic polymer may be die-cut, laser scored, or cut via any other method apparent to one of ordinary skill in the art. Alternatively, the lattice pattern may be formed via a mold in the shape of the desired lattice pattern, where melted elastic theromoplastic may be disposed within the mold and cooled, forming the resultant lattice pattern.

The resulting fabric composition 10 is stretchable in at least one direction; preferably, in at least two directions, and most preferably in all directions. The open pattern 16 also provides the resulting composite 10 with the ability to maintain its compression characteristics longer, as well as, maintain elasticity longer than known stretchable fabrics. Therefore, it is understood that the pattern 16 can be any shape and dimension suitable for the requirements of the resulting fabric composite 10, or end use desired for the item constructed from the fabric composite.

Constructing the fabric composite 10 is accomplished by bonding the first layer 12 to the second layer 14. Such bonding can be accomplished using various known methods for bonding thermoplastic materials, including through sonic welding, thermal bonding, mechanical bonding or other like bonding of the two layers together. Alternatively, as shown in FIG. 1, the fabric composite 10 may include a middle layer 18 comprising a suitable adhesive or primer. Examples of adhesives useful for bonding the first layer 12 together with the second layer 14 include heat activated adhesive, UV activated adhesive, and pressure activated adhesive.

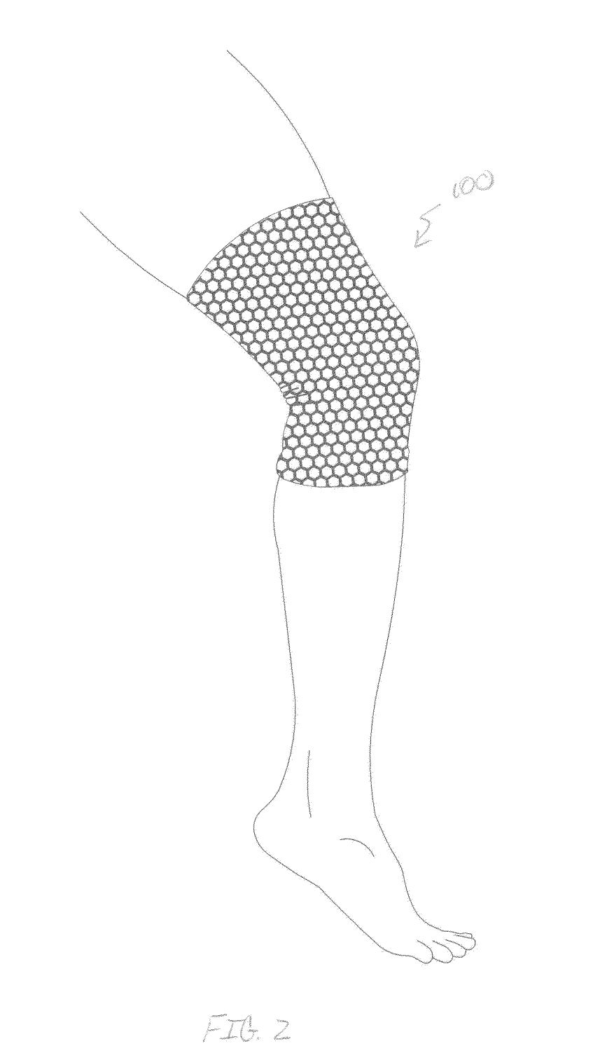

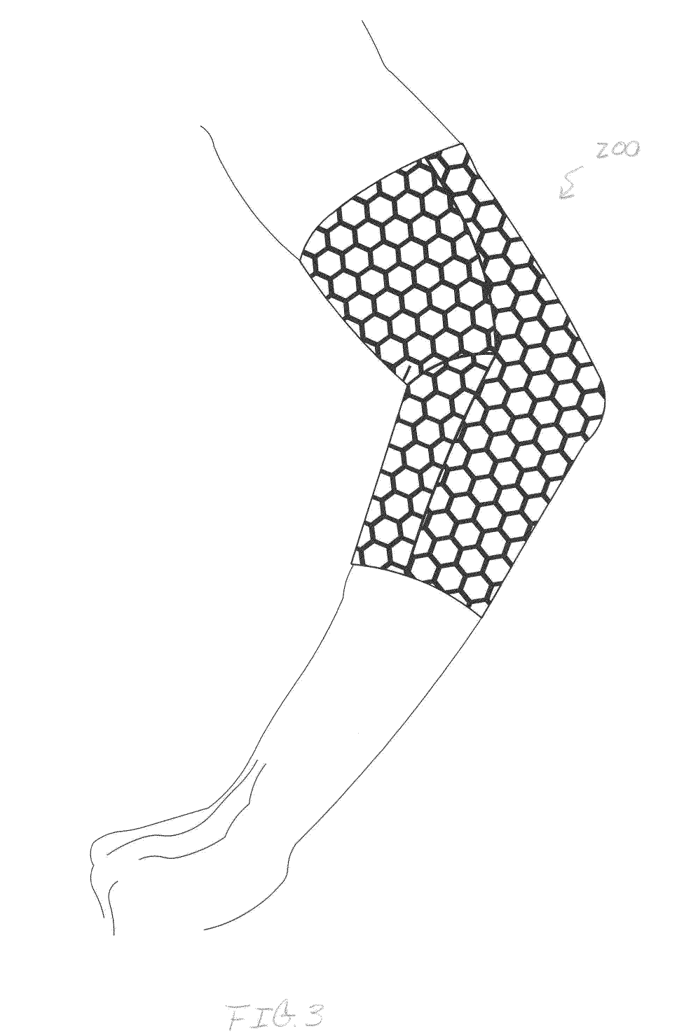

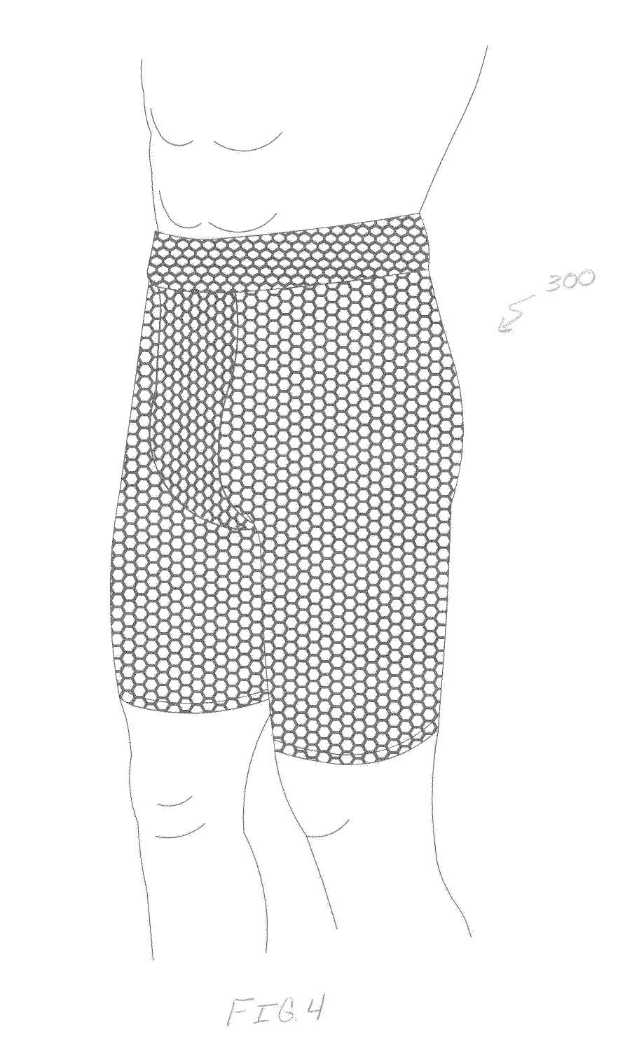

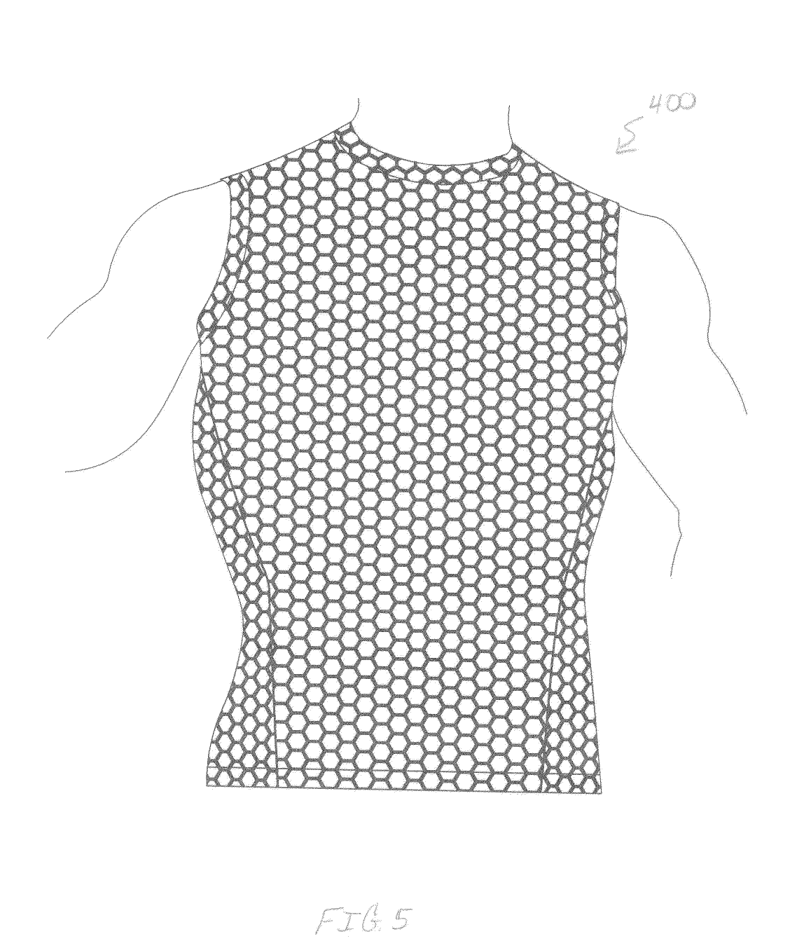

The advantages of strength, stretchability, tear resistance and elasticity of the present fabric composition 10 make it suitable for constructing a variety of garments useful for a multitude of athletic activities, as well as medical applications, such as joint support. FIGS. 2-5 illustrate several items that can be constructed from the present fabric composite. These items include a knee support 100 (FIG. 2), an elbow support 200 (FIG. 3), compression shorts 300 (FIG. 4) and a compression shirt 400 (FIG. 5). The present fabric composite 10 with its lattice webbing or spider web pattern provides a greater degree of breathability than previous fabrics, which is important for the comfort of the wearer.

In addition to the above uses and advantages, the material of the second layer 14 naturally imparts a smooth side and a tacky side to the layer. Preferably, the second layer 14 may have a matte side and a glossy side, wherein the matte side presents a relatively smooth texture and the glossy side presents a relatively tacky texture. Therefore, depending on the side on which the second layer 14 is applied to the first layer 12, the resulting fabric composite may have an exposed tacky side or an exposed smooth side.

The tacky side may be advantageous for use in garments where gripping ability is desired or needed. For example, the tacky side may be useful for use on the outside of biking shorts to better maintain the rider on the seat. Moreover, a composite having the tacky side exposed may be used for other articles and accessories, such as, for example, gloves that may be used for gripping, such as football gloves, baseball gloves, soccer goalie gloves, and other like articles. Alternatively, the smooth side may be advantageous for use in items close to the skin, such as the knee support 100 and elbow support 200 presented above, where it may be desired to reduce the amount of friction between the article and

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A multilayer fabric composite comprising:
a first layer comprising a stretchable fabric; and,
a second layer comprising an elastic polymer in a lattice pattern,
wherein the first layer and second layer are bonded together forming the composite.

2. The composite of claim 1, wherein the first layer comprises spandex.

3. The composite of claim 1, wherein the second layer comprises an elastic polyurethane.

4. The composite of claim 1, wherein the lattice pattern is selected from the group consisting of an open lattice pattern and a reverse lattice pattern.

5. The composite of claim 1, wherein the composite further comprises a middle adhesive layer bonding the first layer and the second layer together.

6. The composite of claim 1, wherein the first layer and the second layer are bonded together through a process selected from the group consisting of sonic welding, thermal welding, adhesive and mechanical bonding.

7. The composite of claim 1, wherein the second layer has a tacky side and a smooth side, wherein the tacky side is bonded together with the first layer and the smooth side is exposed.

8. The composite of claim 1, wherein the second layer has a tacky side and a smooth side, wherein the smooth side is bonded together with the first layer and the tacky side is exposed.

9. The composite of claim 1, wherein the composite is stretchable in at least one direction.

10. The composite fabric of claim 1, wherein the composite is stretchable in a plurality of dimensions.

11. A compression fabric for use in garments, the fabric comprising:
a first layer comprising a stretchable fabric; and,
a second layer comprising an elastic polymer, wherein the second layer forms an open lattice pattern,
wherein the first layer and the second layer are bonded together via thermal, adhesive, ultra-sonic or mechanical bonding forming a fabric for use in constructing a compression garment.

12. The compression fabric of claim 11, wherein the first layer is spandex.

13. The compression fabric of claim 11, wherein the second layer is an elastic urethane.

14. The compression fabric of claim 13, wherein the open lattice pattern is a discontinuous open pattern.

15. The compression fabric of claim 13, wherein the second layer has a webbing configuration.

16. The compression fabric of claim 11, wherein the compression garment is an elbow support.

17. The compression fabric of claim 11, wherein the compression garment is a knee support.

18. The compression fabric of claim 11, wherein the compression garment is a compression shirt.

19. The compression fabric of claim 11, wherein the compression garment is compression shorts.

20. A method for constructing a compression item, the method comprising the steps of:
providing a first layer comprising a stretchable fabric;
providing a second layer comprising an elastic polymer having a lattice configuration;
bonding the first layer with the second layer to form a composite fabric; and,
constructing a compression item having a desired shape.
